(19) United States
(12) Patent Application Publication
(10) Pub. No.: US 2010/0263519 A1
(43) Pub. Date: Oct. 21, 2010

(54) SET TOP BOX

(75) Inventors: TAI-MING LU, Tu-Cheng (TW); MIN-WEI LI, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/650,767

(22) Filed: Dec. 31, 2009

(30) Foreign Application Priority Data
Apr. 16, 2009 (CN) 200910301590.0

(51) Int. Cl. G10H 1/08

(52) U.S. Cl. 84/625

(57) ABSTRACT

A set top box includes a central processing unit, which generates the first accompaniment signals according to a music file, when voice signals is received, they will be converted into stereo voice signals, and the stereo voice signals is converted into digital voice signals, and the set top box adjusts the first accompaniment signals to output second accompaniment signals, mixes the second accompaniment signals and the digital voice signals to output mixing audio signals to the central processing unit, at last converts the mixing audio signals into digital stereo signals, and outputs the digital stereo signals.

### BACKGROUND

1. Technical Field

Embodiments of the present disclosure relate to devices that process audio signals, and more particularly to a set top box that processes audio signals.

2. Description of Related Art

With the advent of technology, digitized audio media has gained popularity. A set top box (STB) may be used to provide audio digitization, such as a karaoke function.

Presently, due to digital-to-analog (D/A) and analog-to-digital (A/D) conversions, the set top box usually may output a delayed audio signals when the set top box is providing the karaoke function. As a result, the video and audio output by the set top box are usually difficult to synchronize.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a diagram of one embodiment of a set top box of the present disclosure; and

FIG. 2 is a diagram of another embodiment of a set top box of the present disclosure.

### DETAILED DESCRIPTION

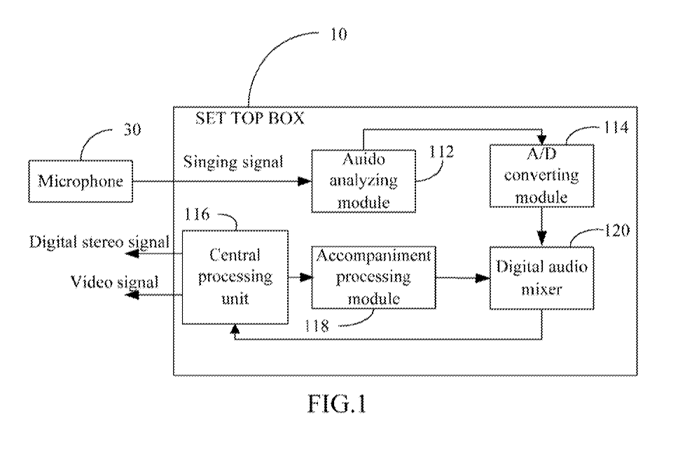

FIG. 1 is a diagram of one embodiment of a set top box 10 of the present disclosure. In one embodiment, the set top box 10 includes an audio analyzing module 112, an A/D converting module 114, a central processing unit 116, an accompaniment processing module 118, and a digital audio mixer 124. In one embodiment, the set top box 10 is connected to a microphone 30 to process voice signals input by the microphone 30, and output digital stereo signals.

In one embodiment, the audio analyzing module 112 is connected to the microphone 30, and is operable to receive monaural voice signals from the microphone 30, and convert the voice signals into stereo voice signals.

The A/D converting module 114, connected to the audio analyzing module 112, is operable to receive the stereo voice signals from the audio analyzing module 112, and convert the stereo voice signals into digital voice signals.

The central processing unit 116 is operable to output signals corresponding to music files stored in the set top box 10, to the accompaniment processing module 118. These signals are known as first accompaniment signals.

The accompaniment processing module 118, connected to the central processing unit 116, is operable to adjust attributes of the first accompaniment signals to output second accompaniment signals. The attributes comprise volume, tone, switching mode and mode of accompaniment mode of the first accompaniment signals. In one embodiment, the accompaniment processing module 118 connects to the central processing unit 116 via a selective one of an inter-IC sound (I²S) Bus, a normal bus, and a pulse code modulation (PCM) bus.

The digital audio mixer 120 is operable to mix the second accompaniment signals from the accompaniment processing module 118 and the digital voice signals from the A/D converting module 114 to output mixing audio signals (i.e., signals that have been mixed) to the central processing unit 116. In one embodiment, the input of the digital audio mixer 120 is connected to the A/D converting module 114 and the accompaniment processing module 118, and the output of the digital audio mixer 120 is connected to the central processing unit 116.

In one embodiment, the mixing audio signals are transmitted to the central processing unit 116 via one of the I²S Bus, the normal bus, and the PCM bus. In other words, the digital audio mixer 120 is connected to the central processing unit 116 via one of the I²S Bus, the normal bus, and the PCM bus.

In one embodiment, the central processing unit 116 is further operable to convert the mixing audio signals into digital stereo signals, and output the digital stereo signals. In one embodiment, the central processing unit 116 is further operable to code and decode video signals. In this disclosure, the voice signals are converted into the digital stereo signals via one A/D conversion, and thereby the delay time of the digital stereo signals is reduced.

Meanwhile, the central processing unit 116 is further operable to output video signals. Due to the reduced delay time of the digital stereo signals, the synchronization between the un-synchronization between the video signals and the digital stereo signals is improved.

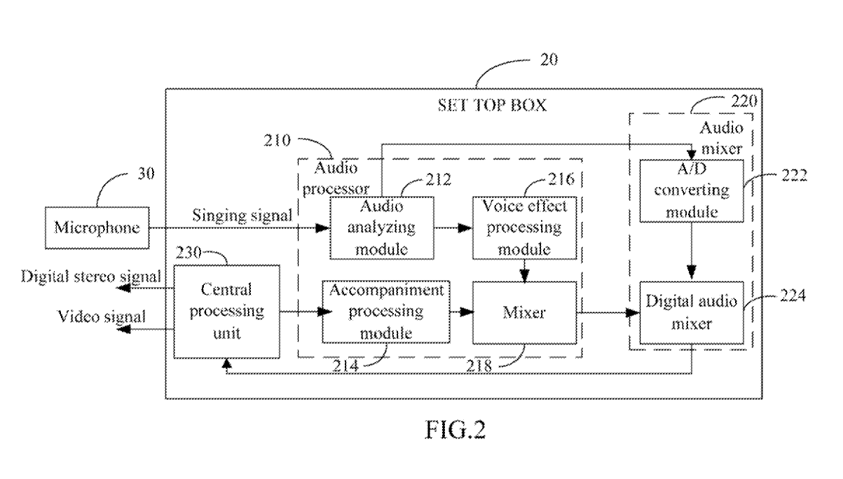

FIG. 2 is a diagram of another embodiment of a set top 20 box of the present disclosure. In one embodiment, the set top box 20 includes an audio processor 210, an audio mixer 220, and a central processing unit 230. The audio processor 210 includes an audio analyzing module 212, an accompaniment processing module 214, a voice effect processing module 216, and a mixer 218. The audio mixer 220 includes an A/D converting module 222 and a digital audio mixer 224.

In one embodiment, the central processing unit 230, the accompaniment processing module 214, and the A/D converting module 222 have respectively the same function as the central processing unit 116, the accompaniment processing module 118, and the A/D converting module 114 in FIG. 1, and therefore the detailed descriptions are omitted.

In one embodiment, the audio processor 210 is connected to the central processing unit 230, and is operable to process first accompaniment signals and the voice signals. In one embodiment, the audio processor 210 may be an integrated chip, such as one of a series of YSS915 chips. In one embodiment, the audio processor 210 can be connected to the central processing unit 230 via one of the I²S Bus, the normal bus, and the PCM bus.

In one embodiment, the audio analyzing module 212, connected to the microphone 30, is operable to receive voice signals input by the microphone 30, and convert the monaural signals into stereo voice signals.

In one embodiment, the audio analyzing module 212 is further operable to generate audio parameters according to the voice signals. In one embodiment, the audio parameters include volume and tone of the voice signals.

In one embodiment, the voice effect processing module 216, connected to the audio analyzing module 212 is operable to generate voice effect signals according to the audio parameters. In one embodiment, the voice effect signals include reverberation, re-echo, and inflection. In one embodiment, the voice effect signals are digital signals.

The mixer 218 is operable to mix the second accompaniment signals from the accompaniment processing module 214 and the voice effect signals from the voice effect processing module 216 to output third accompaniment signals to the digital audio mixer 224. In one embodiment, an input of the mixer 218 is connected to the voice effect processing module 216 and the accompaniment processing module 214, and an output of the mixer 218 is connected to the digital audio mixer 224.

The audio mixer 220 is operable to mix the third accompaniment signals and the digital voice signals to output mixing audio signals to the central processing unit 230.

In one embodiment, an input of the audio mixer 220 is connected to the audio processor 210, and an output of the audio mixer 220 is connected to the central processing unit 230.

In one embodiment, the audio mixer 220 connects to the audio processor 210 and the central processing unit 230 via one of the I²S Bus, the normal bus, and the PCM bus. In one embodiment, the stereo voice signals can be converted into the digital voice signals via the audio mixer 220. The audio mixer 220 may be an integrated chip, such as digital mixer embedded A/D converter.

In one embodiment, the digital audio mixer 224 connected to the mixer 218 is operable to mix the third accompaniment signals from the mixer 218 and the digital voice signals from the A/D converting module 222 to output mixing audio signals to the central processing unit 230. In one embodiment, the input of the digital audio mixer 224 is connected to the mixer 218 and the A/D converting module 222.

In one embodiment, the central processing unit 230 is further operable to code and decode video signals. In this disclosure, the voice signals are converted into the digital stereo signals via one A/D conversion, and thereby the delay time of the digital stereo signals is reduced.

Meanwhile, the central processing unit 230 is further operable to output the video signals. Due to the reduced delay time of the digital stereo signals, the synchronization between the video signals and the digital stereo signals is improved.

In this disclosure, the set top box 10 can reduce the frequency of A/D conversion through the audio analyzing module 112, the A/D converting module 114, the central processing unit 116, the accompaniment processing module 118, and the digital audio mixer 120. The set top box 10 can reduce the classes of processing, reduce the audio processing delay time, and improve the quality of the voice signals, thereby reducing time during which audio signals and video signals are not synchronized, and provide video and audio synchronization.

Although the features and elements of the present disclosure are described in various inventive embodiments in particular combinations, each feature or element can be configured alone or in various within the principles of the present disclosure to the full extent indicated by the broad general meaning of the terms in which the appended claims are expressed.

What is claimed is:

1. A set top box, comprising:
an audio analyzing module operable to receive voice signals from a microphone, and convert the received voice signals into stereo voice signals;
an analog-to-digital (A/D) converting module operable to convert the stereo voice signals into digital voice signals;
a central processing unit (CPU) operable to output first accompaniment signals according to a music file;
an accompaniment processing module operable to adjust attributes of the first accompaniment signals to output second accompaniment signals according to the first accompaniment signals, wherein the attributes comprise volume, tone, switching mode and accompaniment mode of the first accompaniment signals; and
a digital audio mixer operable to mix the second accompaniment signals and the digital voice signals, to output mixing audio signals to the CPU;
wherein the CPU converts the mixing audio signals into digital stereo signals.

2. The set top box as claimed in claim 1, wherein the CPU is further operable to output digital video signals accompanied by the stereo signals.

3. The set top box as claimed in claim 1, wherein the audio analyzing module is further operable to generate audio parameters according to the voice signals.

4. The set top box as claimed in claim 3, wherein the audio parameters comprise volume and tone of the voice signals.

5. The set top box as claimed in claim 3, further comprising a voice effect processing module connected to the audio analyzing module, operable to generate voice effect signals according to the audio parameters.

6. The set top box as claimed in claim 5, wherein the voice effect signals comprise reverberation, re-echo, and inflection.

7. The set top box as claimed in claim 5, further comprising a mixer operable to mix the second accompaniment signals and the voice effect signals to output third accompaniment signals to the digital audio mixer.

8. The set top box as claimed in claim 7, wherein the digital audio mixer is further operable to mix the third accompaniment signals and the digital voice signals to output mixing audio signals to the CPU.
